(19) United States
(12) Patent Application Publication
(10) Pub. No.: US 2022/0007565 A1
(43) Pub. Date: Jan. 13, 2022

(54) TRAVELING PATH PLANNING SYSTEM AND METHOD OF AUTOMATIC HARVESTER

(71) Applicant: FJ Dynamics Technology Co., Ltd, Xiangyang (CN)

(72) Inventors: Di Wu, Nanjing (CN); BO WANG, Xiangyang (CN); XIAO ZHANG, Xiangyang (CN); Yuan Yao, Nanjing (CN); QING-QUAN WANG, Xiangyang (CN); SHUN FAN, Xiangyang (CN); YONG-QUAN SHEN, Xiangyang (CN)

(21) Appl. No.: 17/487,227

(22) Filed: Sep. 28, 2021

Related U.S. Application Data
(63) Continuation-in-part of application No. PCT/CN2019/106710, filed on Sep. 19, 2019.

(30) Foreign Application Priority Data
Apr. 9, 2019 (CN) 201910280737.6

(51) Int. Cl. A01B 69/04; G05D 1/02; A01B 69/00

(52) U.S. Cl. CPC A01B 69/008; G05D 1/0278; G05D 2201/0201; A01B 69/001; G05D 1/0246

(57) ABSTRACT

A traveling path planning method of an automatic harvester includes steps of (a) detecting and forming, by a detection device, a basic farmland information; and (b) receiving and analyzing, by a path planning device, the basic farmland information, and planning a path for the automatic harvester to travel.

### FIELD

The subject matter relates to field of automatic harvesters, and more particularly, to a traveling path planning system and a traveling path planning method of an automatic harvester, for planning an optimal or a preferable traveling path.

### BACKGROUND

With the development of science and technology, the field of agricultural machinery has also been developed. Nowadays, farming by manpower is never seen, and automatic harvesters have been widely used in various links such as sowing, plant protecting, and harvesting. Modern agriculture has entered the era of mechanization. Furthermore, as the means of agricultural production continue to increase in recent years, agricultural machinery is continuously developed. To improve the economic benefits of agriculture and promote economic and social development, various agricultural machinery has been emerged and entered the countryside, which bring benefits to farmers. In other words, the modern agriculture increases the product efficiency and promotes economic development. The agricultural machinery improves the efficiency of agricultural production, brings great convenience to the farmers, and plays an important role in the rapid development of agriculture.

Therefore, further development and improvement of the agricultural machinery can bring continuously progress to the current agriculture. Generally, the agricultural machinery may have to operate on uneven lands or fields. Therefore, the farmers, the operators, or the drivers of the automatic harvesters may need to endure strong jolt and discomfort when driving the automatic harvesters, and a great labor intensity can thus be imagined. Therefore, the automatic harvesters begin to develop toward the direction of autonomous driving. The planning of a traveling path of the automatic harvester is a key factor for autonomous driving. In addition to automatic driving, when the farmers, operators, or the drivers of the automatic harvester need to drive the automatic harvesters, an optimal or a shortest path ought to be planned, to reduce the length of driving time and the fatigue of the farmers or operators.

### SUMMARY

An advantage of the present disclosure is that a traveling path planning method and a traveling path planning system of an automatic harvester are provided, which can plan an optimal path through manual, automatic or semi-automatic settings, to protect the automatic harvester and reduce the fatigue of the farmers or operators.

An advantage of the present disclosure is that a traveling path planning system and a traveling path planning method of an automatic harvester are provided. An optimal traveling path can be provided according to various information. Furthermore, the traveling path can be planned according to basic farmland information, working information, and traveling information.

An advantage of the present disclosure is that a traveling path planning system and a traveling path planning method of an automatic harvester are provided. An obstacle information is obtained in advance, so as to avoid the obstacle during the path planning or during the traveling.

An advantage of the present disclosure is that a traveling path planning system and a traveling path planning method of an automatic harvester are provided.

An obstacle information is obtained in real time, to modify the traveling path, avoid the obstacle, or directly stop the automatic harvester from moving forward. In other words, if an obstacle like a small animal or a person suddenly occurs, the traveling path planning system stops the automatic harvester to ensure safety.

An advantage of the present disclosure is that a traveling path planning system and a traveling path planning method of an automatic harvester are provided. Each time an obstacle information is generated, the obstacle information is transmitted to a path planning module for further analysis, causing the traveling path planning module to re-plans another traveling path.

An advantage of the present disclosure is that a traveling path planning system and a traveling path planning method of an automatic harvester are provided. When a probe touches an obstacle, the path planning device determines whether the automatic harvester must stop moving.

An advantage of the present disclosure is that a traveling path planning system and a traveling path planning method of an automatic harvester are provided. When an infrared detector is used to detect whether an obstacle suddenly enters a dangerous area in front of the automatic harvester.

Another advantage of the present disclosure is that precision parts and complicated structure are not required. The manufacturing process is simple, and the cost is low.

Other advantages and features of the present disclosure are realized by the following detailed description, and can be realized by the combination of methods and devices in the appended claims.

In order to realize the above objectives and advantages of the present disclosure, the present disclosure provides a traveling path planning method of an automatic harvester, including following steps: (a) detecting and forming, by a detection device, a basic farmland information; and (b) receiving and analyzing, by a path planning device, the basic farmland information, and planning a traveling path of the automatic harvester.

According to the method of the present disclosure, the basic farmland information comprises size, surface area, shape, coordinates, or crop category.

According to the method of the present disclosure, a traveling mode of the automatic harvester is preset by a path setting module of the path planning device, and a traveling information is generated.

According to the method of the present disclosure, the traveling information comprises a traveling path of homocentric-squares-shaped or zigzag-shaped, or an optimal path or a shortest path, or a path being spiral from outwards to inwards in circles.

According to the method of the present disclosure, the traveling path of homocentric-squares-shaped is selected when a farmland land is square, and the traveling path of zigzag-shaped is selected when the farmland is rectangular.

According to the method of the present disclosure, in step (a), the basic farmland information is obtained by an automatic detection module through a fixed point detection or a moving detection.

According to the method of the present disclosure, the automatic detection module is one of an infrared sensor, a laser sensor, an ultrasonic sensor, an image sensor, or a GPS satellite positioning module.

According to the method of the present disclosure, step (a) further includes detecting, through an obstacle pre-detector, whether any obstacle exists, and generating an obstacle information and sending the obstacle information to the path planning device.

According to the method of the present disclosure, when the automatic harvester is driving, the method further includes generating, by an obstacle driving detector, an obstacle information when an obstacle is detected, and sending the obstacle information to the path planning device; determining, by the path planning device, whether the automatic harvester immediately stops, keeps driving, or re-plans another traveling path accordingly.

In order to realize the above objectives and advantages of the present disclosure, the present disclosure provides a traveling path planning system applied in an automatic harvester, including: a detection device configured to obtain a basic farmland information of a farmland; and a path planning device connected to the detection device, and configured to analyze the basic farmland information of the detection device and planning a traveling path of the automatic harvester.

According to an embodiment of the present disclosure, the basic farmland information comprises size, surface area, shape, coordinates, or crop category.

According to an embodiment of the present disclosure, the path planning device comprises a path setting module, which is configured to preset a traveling mode of the automatic harvester and generate a traveling information.

According to an embodiment of the present disclosure, the traveling mode is homocentric-squares-shaped or zigzag-shaped, or has an optimal path or a shortest path, or being spiral from outwards to inwards in circles.

According to an embodiment of the present disclosure, the detection device includes at least one automatic detection module connected to the path planning device, the automatic detection module is configured to obtain the basic farmland information and transmit the basic farmland information to the path planning device.

According to an embodiment of the present disclosure, the automatic detection module is disposed on an automatic harvester, an unmanned aircraft, or a wireless detector to perform the moving detection.

According to an embodiment of the present disclosure, the automatic detection module is one of an infrared sensor, a laser sensor, an ultrasonic sensor, an image sensor, or a GPS satellite positioning module.

According to an embodiment of the present disclosure, the detection device comprises at least one manual setting module connected to the path planning device, wherein a basic farmland information is input to the path planning device through the manual setting module.

According to an embodiment of the present disclosure, the detection device includes at least one obstacle pre-detector connected to the path planning device, the obstacle pre-detector is configured to obtain an obstacle information through a fixed point detection or a moving detection, and the obstacle information is sent to the path planning device.

According to an embodiment of the present disclosure, the detection device further includes at least one obstacle driving detector connected to the path planning device, the obstacle driving detector is disposed on the automatic harvester, and is configured to send an obstacle information to the path planning device when the automatic harvester encounters an obstacle, and the path planning device is further configured to re-plan another traveling path according to the obstacle information.

According to an embodiment of the present disclosure, the obstacle driving detector includes a driving capturing sensor, the driving capturing sensor comprises a plurality of cameras surrounding the automatic harvester and configured to collect images around the automatic harvester.

According to an embodiment of the present disclosure, the obstacle driving detector includes at least one probe disposed in front of the automatic harvester, the probe is configured to detect whether any obstacle exists in front of the automatic harvester.

According to an embodiment of the present disclosure, the obstacle driving detector includes at least one infrared detector disposed in front of the automatic harvester, the infrared detector is configured to sense people or animals that suddenly approach the automatic harvester.

According to an embodiment of the present disclosure, the traveling path planning system is set in an automatic harvester, a remote control, a smart phone, a radio control, or a smart tablet.

Through the following description and the drawings, the further objectives and advantages of the present disclosure can be realized.

These objectives, features and advantages of the present disclosure can be explained in by the following detailed description, drawings and claims.

### BRIEF DESCRIPTION OF THE DRAWINGS

FIG. 1 is a block diagram of a traveling path planning system of an automatic harvester according to an embodiment of the present disclosure.

FIG. 2 is a block diagram of a detection device according to an embodiment of the present disclosure.

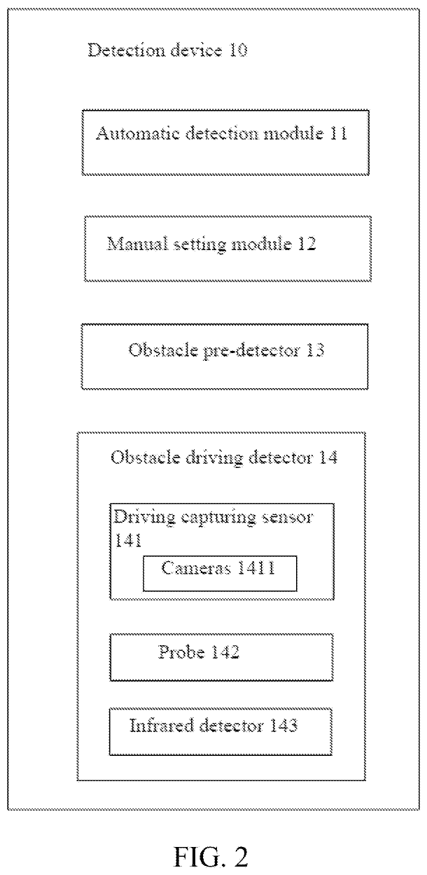

FIG. 3 is a diagrammatic view of a traveling mode of homocentric-squares-shaped planned by a traveling path planning system according to an embodiment of the present disclosure.

FIG. 4 is a diagrammatic view of a traveling mode of zigzag-shaped planned by the a traveling path planning system according to an embodiment of the present disclosure.

FIG. 5 is a block diagram of an automatic harvester according to an embodiment of the present disclosure.

FIG. 6 is a flowchart of a traveling path planning method of an automatic harvester according to an embodiment of the present disclosure.

### DETAILED DESCRIPTION

The following description is used to disclose the present disclosure so that those skilled in the art can implement the present disclosure. The preferred embodiments in the following description are only examples, and those skilled in the art can think of other obvious variations. The basic principles of the present disclosure defined in the following description can be applied to other embodiments, modifications, improvements, equivalents, and other technical solutions that do not deviate from the spirit and scope of the present disclosure.

Those skilled in the art should understand that, in the disclosure of the present disclosure, an orientation or a positional relationship indicated by the terms “longitudinal”, “lateral”, “upper”, “lower”, “front”, “rear”, “left”, “right”, “vertical”, “horizontal”, “top”, “bottom”, “inner”, “outer”, etc. is based on the orientation or the positional relationship shown in the drawings, which is only for the convenience of describing the present disclosure and for simplifying the description, rather than indicating or implying a device or an element must have a specific orientation, and is constructed and operated in a specific orientation, so the above terms should not be understood as a limitation of the present disclosure.

It can be understood that the term “a” should be understood as “at least one” or “one or more”, that is, in one embodiment, the number of a kind of element may be one, and in another embodiment, the number of the kind of element can be more than one, and the term “one” cannot be understood as a restriction on the number.

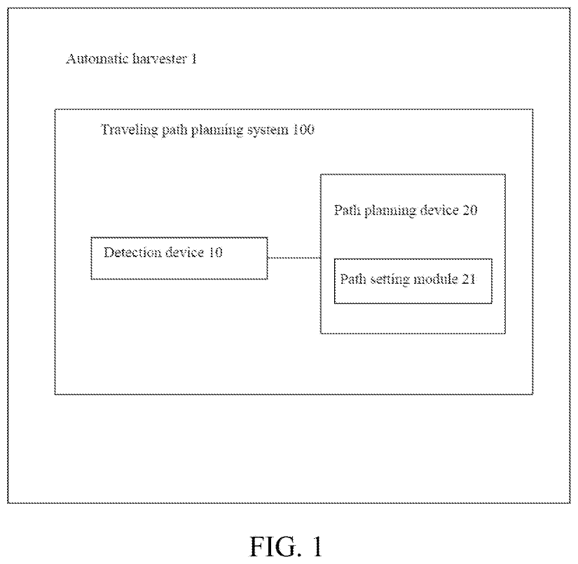

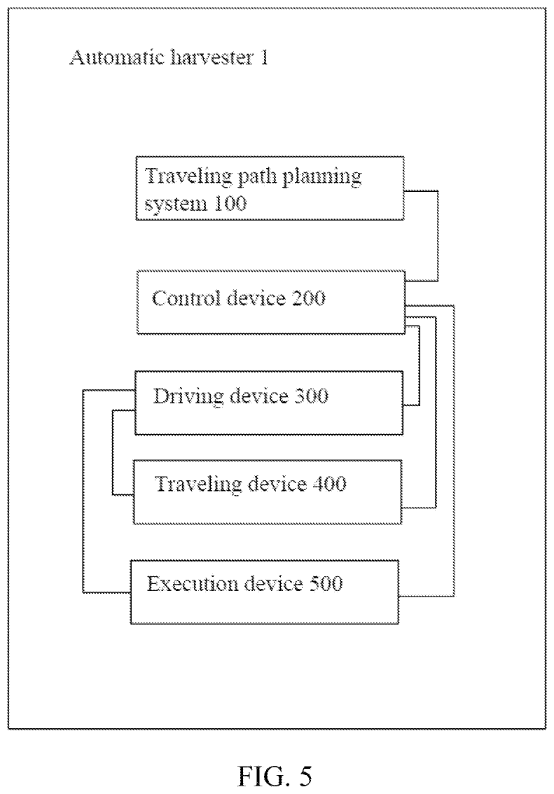

Referring to FIGS. 1 and 5, an embodiment of a traveling path planning system and a traveling path planning method of an automatic harvester are illustrated. The automatic harvester 1 plans a traveling path through the traveling path planning system 100 during operation. The planning of the traveling path takes into account various conditions of a farmland or field, as well as various ways of agricultural operation. Furthermore, the traveling path planning system 100 plans the traveling path according to size, shape, and features of the farmland or field, so that an optimal traveling path can be obtained. In other words, the traveling path planning system 100 is applicable to the automatic harvester 1 to plan the traveling path of the automatic harvester 1 in advance. In particular, the traveling path planning system 100 can be used not only for the harvester, but is also applicable to various agricultural machines such as rice transplanters, plant protection machines, transplanting machines, scarifiers, soil preparation machines, etc., not being limited in the present disclosure. In addition to automatic harvester, the traveling path planning system can be installed in a remote control, a smart phone, a radio control, or a smart tablet.

In the embodiment of the disclosure, the traveling path planning system 100 includes a detection device 10 and a path planning device 20. The detection device 10 is connected to the path planning device 20. The connection mode may be a wired connection or a wireless connection, not limited in the disclosure. Furthermore, the detection device 10 is used to obtain information of surface area, shape, and crop category of the farmland or the field. The surface area or shape are related to the scope of the field where the automatic harvester is to operate. The path planning device 20 includes a path setting module 21, which is connected to the detection device 10 and used to set a traveling mode of the automatic harvester 1. The traveling mode may be homocentric-squares-shaped or zigzag-shaped, or may have an optimal path or a shortest path, or spiral from outwards to inwards in circles. The path planning device 20 plans the traveling path of the automatic harvester 1 according to the information from the detection device 10.

In the embodiment of the disclosure, the detection device 10 includes at least one automatic detection module 11 and a manual setting module 12. Each of the automatic detection module 11 and the manual setting module 12 is connected to the path planning device 20. The automatic detection module 11 can perform a detection from a fixed point or while moving. The fixed point detection is to set a plurality of the automatic detection modules 11 on the corners of the farmland or field, and obtain a basic farmland information according to the sensing by the automatic detection modules 11, which includes sensing the scope, the shape, the coordinates, and the crop category of the farmland or field. The moving detection is to install the automatic detection module 11 on an automatic harvester, an unmanned aircraft, or a wireless detector, so that the basic farmland information can be obtained as the automatic harvester, the unmanned aircraft, or the operator, moves. The automatic detection module 11 can be an infrared sensor, a laser sensor, an ultrasonic sensor, an image sensor, or a GPS satellite positioning module, etc., not limited in the disclosure. In addition, the manual setting module 12 obtains the basic farmland information in advance such as the scope, the shape, the coordinates, and the crop category of the farmland or land, which can be manually input to the path planning device 20 through the manual setting module 12. The path planning device 20 analyzes the information of the automatic detection module 11 or the manual setting module 12 and the path setting module 21, and plans the traveling path of the automatic harvester 1. In at least one embodiment, the manual setting module 12 is an input device such as a keyboard, a mouse, or a touch panel.

In the embodiment of the disclosure, the detection device 10 further includes an obstacle pre-detector 13, which is used to detect whether any obstacle exists, and generates an obstacle information when an obstacle exists. The obstacle information is then sent to the path planning device 20. The obstacle pre-detector 13 can be designed to perform synchronous detection with the automatic detection module 11. In other words, when the automatic detection module 11 obtains the scope and the shape of the farmland or field, the obstacle pre-detector 13 reveals the obstacle information at the same time. Thus, when the path planning device 20 plans the travel path, the path planning device 20 can also take the obstacle into consideration and plan to avoid it at the same time. In other words, the automatic detection module 11 may also be the obstacle pre-detector 13, which obtains the basic farmland information and the obstacle information simultaneously. The path planning device 20 analyzes the information of the automatic detection module 11, the manual setting module 12, the obstacle pre-detector 13, and the path setting module 21 to plan the traveling path of the automatic harvester 1.

Furthermore, the obstacle pre-detector 13 can be used to distinguish between the obstacle and the crops. The path planning device 20 determines whether the size of the obstacle affects the traveling path according to the obstacle information. If not, the planning of the traveling path is not affected; if yes, the path planning device 20 re-plans another traveling path. The obstacle information may include size, image, coordinates, etc. of the obstacle, not limited in the disclosure. The obstacle pre-detector 13 and the automatic detection module 11 can both perform the fixed point detection or the moving detection synchronously. In addition, the obstacle pre-detector 13 can be an infrared sensor, a laser sensor, an ultrasonic sensor, an image sensor, or a GPS satellite positioning module, etc., not limited in the disclosure.

In the embodiment of the disclosure, the detection device 10 further includes an obstacle driving detector 14, which is used to detect whether any obstacle exists when driving, and further obtains an obstacle information when an obstacle exists. The obstacle information is then sent to the path planning device 20. The path planning device 20 re-plans another travel path according to the obstacle information. The obstacle driving detector 14 is set on the automatic harvester 1, preferably at the front of the automatic harvester 1. As such, when the automatic harvester 1 is driven forward, an obstacle can be directly detected by the obstacle driving detector 14 when there is an obstacle in the path. In particular, when the obstacle is detected by the obstacle driving detector 14, the automatic harvester 1 re-plans the traveling path based on the existing basis. That is, the traveling path of the automatic harvester 1 is planned based on the information of the automatic detection module 11, the manual setting module 12, the obstacle pre-detector 13, and the path setting module 21, and based on this, another traveling path of the automatic harvester 1 is planned further according to the obstacle information from the obstacle driving detector 14.

The obstacle driving detector 14 can distinguish between the obstacle and the crops, obtain the obstacle information such as the size, and transmit the obstacle information including the size to the path planning device 20. The path planning device 20 determines whether the obstacle affects the traveling path. If not, the original planned path is followed; if yes, the obstacle information is transmitted to the path planning device 20 to re-plan another traveling path. In particular, the obstacle driving detector 14 can obtain features from the image and distinguish the obstacle from the crops accordingly. The obstacle driving detector 14 is installed on the automatic harvester 1. Thus, when the automatic harvester 1 is traveling, at least one signal from the forward path, such as signals from the crops and the obstacle, can be obtained. The obstacle driving detector 14 includes a driving capturing sensor 141, which collects images of area around the automatic harvester 1 and forms a video signal. In particular, the driving capturing sensor 141 includes a plurality of cameras 1411 surrounding the automatic harvester 1 to collect the images around the automatic harvester 1 and form the video signal. The obstacle driving detector 14 further includes at least one probe 142, which is disposed at the front of the automatic harvester, to detect any obstacle, such as tree, wall, large rock, pit, puddle, river, etc., at the front of the automatic harvester 1, and to detect the size or other features of the obstacle. The detection information is then sent to the path planning device 20. The path planning device 20 determines whether the automatic harvester must stop moving. In addition, the obstacle driving detector 14 further includes at least one infrared detector 143, which is disposed at the front of the automatic harvester 1 to sense people or animals suddenly entering or crossing the region in front of the automatic harvester 1.

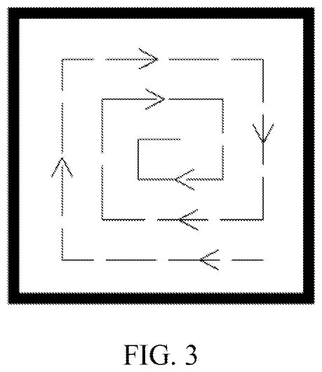

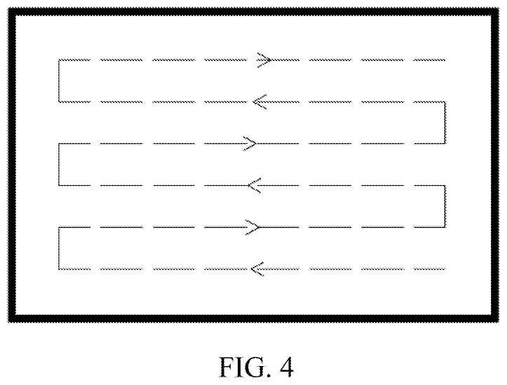

In the embodiment of the disclosure, the path setting module 21 is used to set the traveling mode of the automatic harvester. The path setting module 21 can be a central processing unit (CPU), a microprocessor, or other data processor chip that performs functions of setting the traveling mode. The traveling mode may be homocentric-squares-shaped or zigzag-shaped, or may have an optimal path or a shortest path, or be spiral from outwards to inwards in circles. A user or an operator of the automatic harvester may select the traveling mode of homocentric-squares-shaped or zigzag-shaped in advance according to the shape of the field or farmland. For example, when the field or farmland is square, the homocentric-squares-shape can be used. When the field or farmland is rectangular, the zigzag-shape can be used. As shown in FIG. 3, the outer thick lines represent the edges of the field or farmland, the dashed lines represent the travel path of the automatic harvester, and the arrows represent the travel direction of the automatic harvester. A traveling path of homocentric-squares-shaped is shown in FIG. 3, and the automatic harvester 1 travels according to the dashed lines and arrows. As shown in FIG. 4, the outer thick lines represent the edges of the field or farmland, the dashed lines represent the traveling path of the automatic harvester, and the arrows represent the driving direction of the automatic harvester. A traveling path of zigzag-shaped is shown in FIG. 4, and the automatic harvester 1 travels according to the dashed lines and arrows. The zigzag-shaped pattern means traveling back and forth in rows. Therefore, when the field or farmland is not rectangular but has any other shape, the zigzag-shaped mode can also be used. That is, when the automatic harvester 1 travels to the boundary of one row, it turns back and onto another row, and similarly, when it travels to another boundary, it turns back again. In other words, when the zigzag-shaped mode is selected, the automatic harvester 1 travels back and forth row by row between the boundaries of the field, and each row will bring it to the boundaries of the field. In addition, the setting of the shortest or the optimal path is intelligently achieved. When the user or the operator of the automatic harvester selects such mode, the path planning device 20 plans the shortest or the optimal path according to all options. The shortest path is that the automatic harvester 1 travels in the entire field for a least distance travelled, and the optimal path is an optimal path planned when taking an overall situation into consideration. In addition, the shape of the field or farmland is not always a complete rectangle or a complete square, but may also be irregular. In this case, in addition to the zigzag-shaped path, the shortest path, or the optimal path, a spiral path from outwards to inwards in circles can also be used. The way of spiralling from outwards to inwards in circles is to directly travel inward in circular fashion according to the boundary shape of the field. In other words, the spiral path from outwards to inwards in circles is similar to the zigzag-shaped path, and the difference therebetween are relevant to different shapes of the farmland.

The path planning device 20 plans the traveling path of the automatic harvester 1 based on the information of the detection device 10 and the path setting module 21. Multiple different traveling modes can be used on a same field. The same field can be divided into different regions through the manual setting module 12, which are then associated with different traveling modes. In addition, the optimal path may also be a combination of probabilities including the path of homocentric-squares-shaped, the path of zigzag-shaped, the optimal path, the shortest path, or the path being spiral from outwards to inwards in circles.

As shown in FIG. 5, the automatic harvester 1 includes the traveling path planning system 100, a control device 200, a driving device 300, a traveling device 400, and an execution device 500. Each of the traveling path planning system 100, the driving device 300, the traveling device 400, and the execution device 500 is connected to the control device 200. The control device 200 is a central control traveling path planning system of the automatic harvester 1, which is used to control the various devices of the automatic harvester 1. The driving device 300 is connected to and provides power to the execution device 500, the traveling device 400, and the control device 200. The control device 200 controls the operation of various devices. The driving device 300 can be driven by fuel, electric or hybrid power of fuel and electric, which is not limited in the disclosure. The traveling device 400 is used to drive the automatic harvester 1 to travel by caterpillar tracks, by two wheels, or by four wheels. The execution device 500 is used to perform harvesting operations, such as harvesting. The traveling path planning system 100 is used to plan the traveling path.

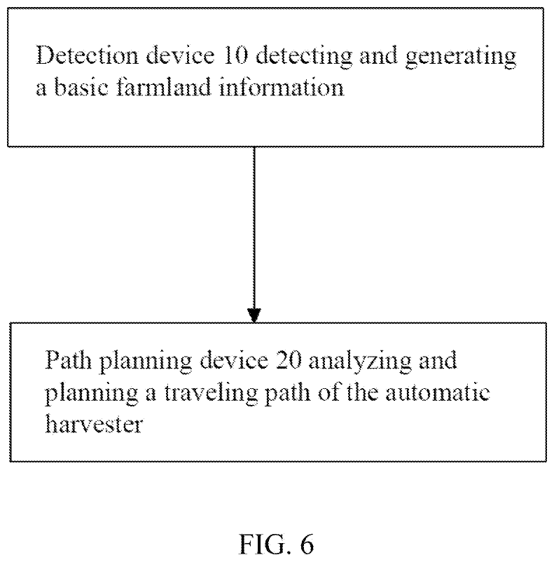

In addition, FIG. 6 illustrates a method for planning a traveling path of an automatic harvester according to the present disclosure. The method includes following steps.

(a) The detection device 10 detects and generates a basic farmland information.

(b) The path planning device 20 receives and analyzes the basic farmland information, and plans a traveling path of the automatic harvester accordingly.

In step (a), the basic farmland information includes information of the farmland such as size, surface area, shape, coordinates, and crop category.

In step (b), the path setting module of the path planning device preset a traveling mode of the automatic harvester and generate a traveling information. The traveling information includes a traveling path of homocentric-squares-shaped or zigzag-shaped, or an optimal path or a shortest path, or a path being spiral from outwards to inwards in circles.

In step (a), the basic farmland information is obtained through an automatic detection module 11, which perform a detection from a fixed point or while moving. In particular, the automatic detection module 11 can cooperate with an automatic harvester, an unmanned aircraft, or a wireless detector to obtain the basic farmland information. In addition, the automatic detection module 11 can be an infrared sensor, a laser sensor, an ultrasonic sensor, an image sensor, or a GPS satellite positioning module.

In step (a), the basic farmland information is manually input through a manual setting module 12.

In step (a), an obstacle pre-detector 13 detects whether any obstacle exists and generates an obstacle information. In particular, the obstacle pre-detector 13 works simultaneously with the automatic detection module 11. Furthermore, in step (a), in addition to the basic farmland information, the obstacle information is also generated when an obstacle exists. Both the basic farmland information and the obstacle information are transmitted to the path planning device 20, which are then analyzed by the path planning device 20.

In step (c), the path of homocentric-squares-shaped is preferred when the farmland is square, and the path of zigzag-shaped is preferred when the farmland is rectangular. In particular, the zigzag-shape path means traveling back and forth in rows.

In particular, when the automatic harvester obtains the traveling path through the traveling path planning method and drives on the farmland according to the traveling path, an obstacle driving detector 14 of the detection device 10 works during the driving process, and generate an obstacle information when an obstacle is detected, which is then sent to the path planning device 20. The path planning device 20 determines whether the automatic harvester 1 immediately stops, keeps driving, or re-plans another traveling path according to the obstacle information. In particular, the path planning device 20 enables the automatic harvester 1 to immediately re-plan a new traveling path after the automatic harvester 1 stops, and restarts the automatic harvester 1 after the new traveling path is planned.

One having ordinary skill in the art will understand that the above details and the embodiments shown in the drawings are only examples, and are not limited in the present disclosure.

The embodiments are only some and not all the embodiments of the present disclosure. Based on the embodiments of the present disclosure, other embodiments obtained by a person of ordinary skill in the art without creative efforts shall be within the scope of the present disclosure.

What is claimed is:

1. A traveling path planning method of an automatic harvester, comprising:
(a) detecting and forming, by a detection device, a basic farmland information; and
(b) receiving and analyzing, by a path planning device, the basic farmland information, and planning a traveling path of the automatic harvester.

2. The traveling path planning method of claim 1, wherein the basic farmland information comprises size, surface area, shape, coordinates, or crop category.

3. The traveling path planning method of claim 1, further comprising:
presetting, by a path setting module of the path planning device, a traveling mode of the automatic harvester and generating a traveling information.

4. The traveling path planning method of claim 3, wherein the traveling information comprises a traveling path of homocentric-squares-shaped or zigzag-shaped, or an optimal path or a shortest path, or a path being spiral from outwards to inwards in circles.

5. The traveling path planning method of claim 4, wherein the traveling path of homocentric-squares-shaped is selected when a farmland land is square, and the traveling path of zigzag-shaped is selected when the farmland is rectangular.

6. The traveling path planning method of claim 1, wherein in step (a), the basic farmland information is obtained by an automatic detection module through a fixed point detection or a moving detection.

7. The traveling path planning method of claim 6, wherein the automatic detection module is one of an infrared sensor, a laser sensor, an ultrasonic sensor, an image sensor, or a GPS satellite positioning module.

8. The traveling path planning method of claim 1, wherein step (a) further comprises:
detecting, through an obstacle pre-detector, whether any obstacle exists;
generating an obstacle information and sending the obstacle information to the path planning device.

9. The traveling path planning method of claim 1, wherein when the automatic harvester is driving, the method further comprises:
generating, by an obstacle driving detector, an obstacle information when an obstacle is detected, and sending the obstacle information to the path planning device;
determining, by the path planning device, whether the automatic harvester immediately stops, keeps driving, or re-plans another traveling path accordingly.

10. A traveling path planning system applied in an automatic harvester, comprising:
a detection device configured to obtain a basic farmland information of a farmland; and
a path planning device connected to the detection device, and configured to analyze the basic farmland information of the detection device and planning a traveling path of the automatic harvester.

11. The traveling path planning system of claim 10, wherein the basic farmland information comprises size, surface area, shape, coordinates, or crop category.

12. The traveling path planning system of claim 10, wherein the path planning device comprises a path setting module, which is configured to preset a traveling mode of the automatic harvester and generate a traveling information.

13. The traveling path planning system of claim 12, wherein the traveling mode is homocentric-squares-shaped or zigzag-shaped, or has an optimal path or a shortest path, or being spiral from outwards to inwards in circles.

14. The traveling path planning system of claim 10, wherein the detection device comprises at least one automatic detection module connected to the path planning device, the automatic detection module is configured to obtain the basic farmland information and transmit the basic farmland information to the path planning device.

15. The traveling path planning system of claim 14, wherein the automatic detection module is disposed on an automatic harvester, an unmanned aircraft, or a wireless detector to perform the moving detection.

16. The traveling path planning system of claim 14, wherein the automatic detection module is one of an infrared sensor, a laser sensor, an ultrasonic sensor, an image sensor, or a GPS satellite positioning module.

17. The traveling path planning system of claim 10, wherein the detection device comprises at least one manual setting module connected to the path planning device, wherein a basic farmland information is input to the path planning device through the manual setting module.

18. The traveling path planning system of claim 10, wherein the detection device comprises at least one obstacle pre-detector connected to the path planning device, the obstacle pre-detector is configured to obtain an obstacle information through a fixed point detection or a moving detection, and the obstacle information is sent to the path planning device.

19. The traveling path planning system of claim 10, wherein the detection device further comprises at least one obstacle driving detector connected to the path planning device, the obstacle driving detector is disposed on the automatic harvester, and is configured to send an an obstacle information to the path planning device when the automatic harvester encounters an obstacle, and the path planning device is further configured to re-plan another traveling path according to the obstacle information.

20. The traveling path planning system of claim 19, wherein the obstacle driving detector comprises a driving capturing sensor, the driving capturing sensor comprises a plurality of cameras surrounding the automatic harvester and configured to collect images around the automatic harvester.
